(19) United States
(12) Patent Application Publication
(10) Pub. No.: US 2015/0112626 A1
(43) Pub. Date: Apr. 23, 2015

(54) METHOD FOR VERIFYING MANUFACTURING MEASUREMENTS USED FOR VIRTUAL ANALYSIS INSTRUMENT IN A FACTORY

(71) Applicant: National Tsing Hua University, Hsinchu (TW)

(72) Inventor: Jia-Lin Liu, Hsinchu (TW)

(73) Assignee: National Tsing Hua University, Hsinchu (TW)

(21) Appl. No.: 14/109,060

(22) Filed: Dec. 17, 2013

(30) Foreign Application Priority Data
Oct. 23, 2013 (TW) 102138174

(51) Int. Cl. G01D 18/00; G06F 17/10

(52) U.S. Cl. CPC G01D 18/00; G06F 17/10
USPC 702/85

(57) ABSTRACT

A method for verifying manufacturing measurements used for predicting outputs by virtual analysis instruments in a factory, which has production equipment and a virtual analysis instrument, comprises steps: using model-building data of the virtual analysis instrument to build a verification model via a PCA method, and obtaining control limits of the verification model; inputting a plurality of pre-verification measurements into the verification model to calculate verification statistic, and using the verification statistic and the control limits to exclude at least one failure value from the pre-verification measurements to generate the validated measurements; and finally inputting the validated measurements into the virtual analysis instrument for predicting the outputs to determine that the manufacturing measurements are valid, and using the production equipment to undertake production according to predictions of the virtual analysis instrument. Thereby, the virtual analysis instrument can be prevented from predicting erroneous output results due to invalid input.

### FIELD OF THE INVENTION

The present invention relates to a verification method, particularly to a method for verifying manufacturing measurements used for predicting the outputs through virtual analysis instruments in factories.

### BACKGROUND OF THE INVENTION

The operators usually rely on the in-process analysis instruments and/or the analysis results of the laboratory to modify the operation conditions and maintain normal operation in a factory, e.g. guaranteeing that the products meet the product specification or ensuring that the treatment of waste gas meets the environmental regulation. Once the in-process instrument is out of order or being maintained, the operators will work blindly. Thus, there are in-process virtual analysis instruments developed, which use a prediction model and the values of the input variables (the values of the operation variables developed via analyzing the historical operation data) to predict the values of the output variables (the values of the quality variables analyzed by the in-process analysis instruments or the laboratory). The input variable is sampled once per 0.1-1 second. However, the output variable is output once per 10 minutes for an in-process physical analysis instruments or once per several hours for a laboratory. If there is an in-process virtual analysis instrument with an effective prediction model, the measurement values of the input variables and the prediction model can be used to predict the values of the output variables instantly. Thus, the operators can quickly modify the operation conditions lest the products depart from the product specification or the waste gas emitted during production violates the environmental regulation.

So far, the related fields normally pay attention to methods for developing prediction models of virtual analysis instruments. For an example, a U.S. Pat. No. 6,243,696 disclosed “Automated Method for Building a Model”, which uses an ANN (Artificial Neural Network) technology and the factory operation data to build a prediction model between input variables and output variables. For another example, a U.S. Pat. No. 6,373,033 disclosed “Model-Based Predictive Control of Thermal Processing”, which uses the previous temperature measurement values and an ANN-based model to predict the temperature value at the next time point, and feeds back the predictive value to a wafer thermal processing controller to stabilize the surface temperature of the wafer. For yet another example, a U.S. Pat. No. 7,313,550 disclosed “Performance of Artificial Neural Network Models in the Presence of Instrumental Noise and Measurement Errors”, which adds appropriate Gaussian noise to input variables and output variables and uses an ANN-based model to simulate the correlation between the variables and the external noise, whereby to increase the accuracy of the prediction model. For still another example, a U.S. Pat. No. 7,505,949 disclosed “Process Model Error Correction Method and System”, which uses measurement values of input variables and output variables to build a first prediction model, and next uses the measurement values of the input variables and the error values of the first prediction model to build a second prediction model, and then uses the errors predicted by the second prediction model to offset the predicted output values of the first prediction model. For a further example, a U.S. Pat. No. 8,250,006 disclosed “Inferential Sensors Developed Using Three-Dimensional Pareto-Front Genetic Programming”, which uses a genetic algorithm to build a virtual analysis instrument and evaluates the performance of gene evolution calculation from three aspects: accuracy, complexity and smoothness, whereby to build an accurate and robust prediction model. For a yet further example, a U.S. Pat. No. 8,296,107 disclosed “Computer Method and Apparatus for Constraining a Non-Linear Approximator of an Empirical Process”, which uses a piecewise approximation method to build a virtual analysis instrument, and which uses transfer functions to define the relationships between input variables and output variables in different zones, and next connects different transfer functions to globally approximate the relationships between input variables and output variables, and then uses a constrained optimization algorithm to converge model parameters. For a still further example, a U.S. Pat. No. 8,429,100 disclosed “Method for Building Adaptive Soft Sensor”, which builds a virtual analysis instrument via updating regional prediction models, and recursively updates prediction models via merging the existing region classes or generating new region classes, whereby the updated virtual analysis instrument can describe new operation behaviors of the process.

The conventional virtual analysis instruments described above are nothing more than using the historical data of input variables and output variables to develop a prediction model able to use in-process measurement values of input variables to correctly and robustly predict the values of output variables. No matter how precise the prediction model is, it would be affected by the failure measurement values to output erroneous prediction results. Accordingly, the present invention proposes a method for verifying the in-process measurement values of input variables and excluding the failure measurement values from affecting the prediction values of the virtual analysis instrument.

### SUMMARY OF THE INVENTION

The primary objective of the present invention is to solve the problem that the conventional virtual analysis instrument is affected by failure measurements to generate incorrect predictions.

To achieve the abovementioned objective, the present invention proposes a method for verifying manufacturing measurements used for predicting outputs by a virtual analysis instrument in a factory, which has production equipment and a virtual analysis instrument where manufacturing measurements are input. The method comprises the steps of:
Step 1: using a PCA (Principal Component Analysis) method and model-building data of a virtual analysis instrument to build a verification model;
Step 2: using the PCA method to obtain verification-model measurements of the verification model, wherein the verification-model measurements include control limits;
Step 3: inputting a plurality of pre-verification measurements into the verification model to calculate verification statistic, and using the verification statistic and the control limits to exclude at least one failure value from the pre-verification measurements to generate validated measurements for the virtual analysis instrument;
Step 4: inputting the validated measurements into the virtual analysis instrument for predicting the outputs; and
Step 5: using the production equipment to undertake production according to predictions of the virtual analysis instrument.

In brief, the present invention builds the verification model, uses the PCA method to verify the pre-verification measurements, and excludes the failure values from the pre-verification measurements to form the post-verification manufacturing measurements. Thereby, the present invention can prevent false pre-verification measurements from directly inputting into the virtual analysis instrument, and prevent the virtual analysis instrument from outputting incorrect predictions.

### BRIEF DESCRIPTION OF THE DRAWINGS

FIG. 1 schematically shows an industrial distillation tower according to one embodiment of the present invention;

FIG. 2 schematically shows the building of a verification model according to one embodiment of the present invention;

FIG. 3A shows a primary flowchart of a verification method according to one embodiment of the present invention; and

FIG. 3B shows a secondary flowchart of a verification method according to one embodiment of the present invention.

### DETAILED DESCRIPTION OF THE PREFERRED EMBODIMENTS

The technical contents of the present invention are described in detail in cooperation with the drawings below.

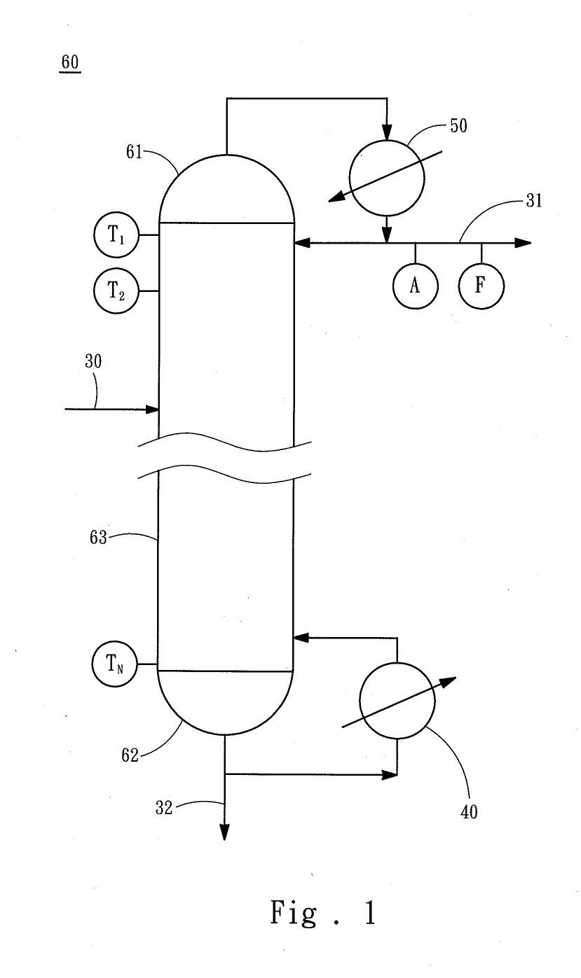

The present invention proposes a method for verifying manufacturing measurements used for predictions in a factory, which has production equipment and a virtual analysis instrument where manufacturing measurements are inputs. For example, the production equipment is an industrial distillation tower, and the manufacturing measurements are the temperature values used in the industrial distillation tower. Refer to FIG. 1 schematically showing an industrial distillation tower according to one embodiment of the present invention. The material to be purified is fed into the industrial distillation tower 60 from a feeder. A reboiler 40, which is arranged at the tower bottom 62, is heated by steam to evaporate the components having lower boiling points into a gaseous phase flowing upward. A condenser 50, which is arranged at the tower top 61, is cooled by water to condense the components having higher boiling points into a liquid phase flowing downward. The gaseous phase components and the liquid phase components fully contact in each layer of the industrial distillation tower 60 and achieve a thermodynamic balance. Then, the lower boiling point components continue to flow upward to form distillate 31 at the tower top 61, and the higher boiling point components continue to flow downward to form residues 32 at the tower bottom 62. The concentration of the distillate 31 at the tower top 61 is an important index for production. Therefore, a virtual analysis instrument A is used to analyze the concentration of the distillate 31. There are also a flow meter and a flow rate control valve F used to modify the concentration of the distillate 31 lest it exceeds the upper limit. In order to learn the concentration of the distillate 31 at the tower top 61 in realtime, a plurality of thermometers T₁, T₂, . . . , T_{N} are respectively arranged at different positions of the tower body 63 to measure temperatures at these positions. The relationship between the historical data of the temperature values at these positions and the concentration of the distillate 31 is used to build a prediction model of the virtual analysis instrument A. As long as the instant temperature values are learned, the concentration of the distillate 31 at the tower top 61 can be predicted immediately. However, if one or more temperature values are false or invalid, the virtual analysis instrument A will predict a wrong concentration of the distillate 31. In such a case, the flow rate control valve F will operate falsely, which may cause damage of the product in production. In this embodiment, whether the temperatures measured by thermometers T₁, T₂, . . . , T_{N} match the rule implied in the historical data is verified to prevent false manufacturing measurements from affecting production in the factory. It should be explained specially that the embodiment of the industrial distillation tower 60 is only to exemplify the present invention but not to limit the scope of the present invention. Any production equipment, manufacturing measurements or virtual analysis instrument according to the spirit of the present invention is to be also included within the scope of the present invention.

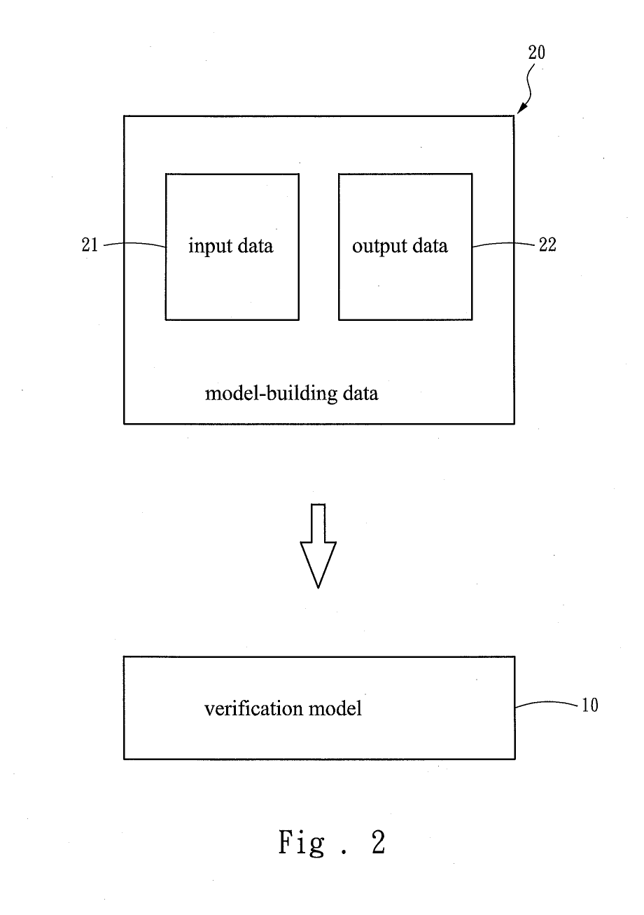

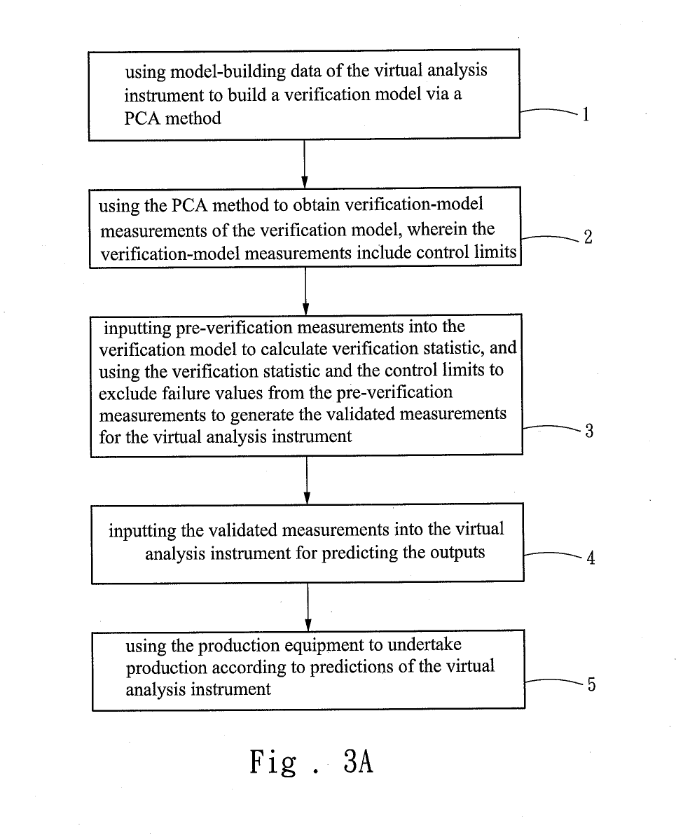

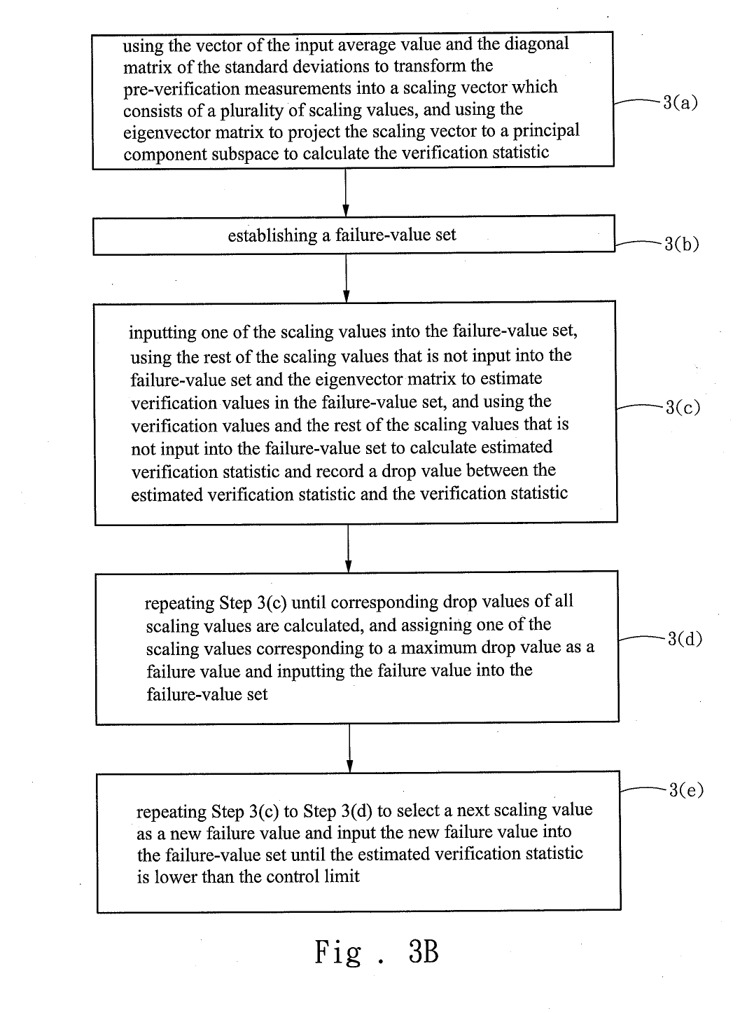

Refer to FIG. 2, FIG. 3A and FIG. 3B. FIG. 2 schematically shows the building of a verification model according to one embodiment of the present invention. FIG. 3A shows a primary flowchart of a verification method according to one embodiment of the present invention. FIG. 3B shows a secondary flowchart of a verification method according to one embodiment of the present invention. The method of the present invention comprises Steps 1-5.

### Step 1:

Model-building data 20 of the virtual analysis instrument are used to build a verification model 10 via a PCA (Principal Component Analysis) method. The model-building data 20 include historical operation data of the virtual analysis instrument. The historical operation data include at least one piece of input data 21 and at least one piece of output data 22. The output data 22 are generated corresponding to the input data 21. Suppose that there are N input variables 21 and M sets of model-building data 20. Thus, the dimension of the data matrix W of the input data 21 is M×N. Each of M sets of the input data 21 is rescaled according to a formula:

X=(W−1 W̅)S⁻¹

whereby each of the M sets of the input data 21 has an average value of zero and the standard deviation of 1,
wherein W̅ is the vector of the average value of M sets of the model-building data 20; 1 is a column vector whose elements are all 1; S is the diagonal matrix of the standard deviations. S=diag[σ₁ σ₂ . . . σ_{N}], wherein σᵢ is the standard deviation of the ith variable. The resealed data X are used to calculate the eigenvector P=[p₁ p₂ . . . p_{N}] of the covariance matrix Σ. The projections obtained via projecting the rescaled data X to the eigenvectors are called the Score vectors T, and T=XP, wherein

X=TₖPₖ^{T}+Tₙ₋ₖPₙ₋ₖ^{T}=\hat{X}+E (1)

wherein Tₖ and Pₖ are respectively the first k terms of the Score vectors and the Loading vectors, and wherein Tₙ₋ₖ and Pₙ₋ₖ are respectively the rest of the Score vectors and the Loading vectors, and wherein \hat{X} describes the systemic part of the PCA, and wherein E is the residual part. While the residual part can be ignored, X≈\hat{X}. In such a case, the first k terms of the eigenvectors expand the principal component (PC) subspace. Thus, the statistic Q is defined by

Q=(x−\hat{x})(x−\hat{x})^{T}=x(I−PₖPₖ^{T})x^{T} (2)

wherein x is a rescaled measurement vector of input variables. Q may be regarded as the error with the new data that is interpreted by the PC subspace constructed with the normal operation data. The control limit of Q is defined by

$${Q}_{α} = {{Θ}_{1} [ \frac{{c}_{α} \sqrt{2 {Θ}_{2} {h}_{0}^{2}}}{{Θ}_{1}} + 1 + \frac{{Θ}_{2} {h}_{0} ( {h}_{0} - 1 )}{{Θ}_{1}^{2}} ]}^{1 / {h}_{0}} \\ {Θ}_{i} = {\sum }_{j = k + 1}^{N} {λ}_{j}^{i} , i = 1 , 2 , 3 \\ {h}_{0} = 1 - \frac{2 {Θ}_{1} {Θ}_{3}}{3 {Θ}_{2}^{2}} , \qquad ( 3 )$$

wherein (1−α) is the confidence interval of a Type I error, and c_{α} is the value of integrating the normal distribution from (1−α) to ∞. T² is another statistic for measuring the Mahalanobis distance between the origin of the PC subspace and the projection of new data, defined by

T²=xPₖΛ⁻¹Pₖ^{T}x^{T} (4)

wherein Λ is a diagonal matrix of the eigenvalues and Λ=diag[λ₁ λ₂ . . . λₖ]. The control limit of T² is defined by

$${T}_{α}^{2} = \frac{k ( M - 1 )}{M - k} {F}_{k , M - 1 , α} \qquad ( 5 )$$

wherein F_{k,M-1,α} is the F-distribution function with the degrees of freedom k and M−1. The verification statistic is calculated with the combined index of Q and T² (Reconstruction-Based Fault Identification Using a Combined Index, Yue, H. H.; Qin, S. J.; Ind. Eng. Chem. Res. 2001, 40, 4403-4414.), which is defined by

$$ϕ = \frac{Q}{{Q}_{α}} + \frac{{T}^{2}}{{T}_{α}^{2}} \qquad ( 6 )$$

The control limit thereof is defined by

φ_{α}=gχ_{α}²(h) (7a)

wherein

$$g = \frac{{Θ}_{2} / {Q}_{α}^{2} + k / {( {T}_{α}^{2} )}^{2}}{{Θ}_{1} / {Q}_{α} + k / {T}_{α}^{2}} , h = \frac{{( {Θ}_{1} / {Q}_{α} + k / {T}_{α}^{2} )}^{2}}{{Θ}_{2} / {Q}_{α}^{2} + k / {( {T}_{α}^{2} )}^{2}} ,$$

and wherein χ_{α}²(h) is the Chi-square distribution of DOF (Degree Of Freedom) h at the confidence level of (1−α).

### Step 2:

The PCA method is used to obtain verification-model measurements of the verification model 10. The verification-model measurements include a control limit (7a), a vector of input average values (7b), a diagonal matrix of standard deviations (7c), a diagonal matrix of corresponding eigenvalues (7d), an eigenvector matrix, and a number of the principal components. The number of the principal components adopts a number whose eigenvalue is greater than 1.

$$\begin{matrix}\overline{w} = [ \begin{matrix}{\overline{w}}_{1} & {\overline{w}}_{2} & … & {\overline{w}}_{N}\end{matrix} ] , {\overline{w}}_{i} = \frac{1}{M} {\sum }_{j = 1}^{M} {w}_{ji} & ( 7 b ) \\ S = [ \begin{matrix}{s}_{1} & 0 & … & 0 \\ 0 & {s}_{2} & ⋱ & ⋮ \\ ⋮ & ⋱ & ⋱ & 0 \\ 0 & … & 0 & {s}_{N}\end{matrix} ] , {s}_{i} = \frac{1}{M - 1} \sqrt{{\sum }_{j = 1}^{M} {( {w}_{ji} - {\overline{w}}_{i} )}^{2}} & ( 7 c ) \\ Σ = \frac{1}{( M - 1 )} {X}^{T} X , Σ {p}_{i} = {λ}_{i} {p}_{i} , i = 1 … k , {λ}_{k} \geq 1 & ( 7 d )\end{matrix}$$

### Step 3:

A plurality of pre-verification measurements (x) are input into the verification model 10 to calculate the verification statistic. The verification statistic and the control limits are used to exclude at least one failure value from the pre-verification measurements (x) to form the input measurements for the virtual analysis instrument. In this embodiment, Step (3) further comprises Steps 3(a)-3(e).

### Step 3(a):

The vector of the input average value and the diagonal matrix of the standard deviations are used to transform the pre-verification measurements into a scaling vector (x) which consists of a plurality of scaling values. Then, the eigenvector matrix is used to project the scaling vector to the principal component subspace to calculate the verification statistic. In other words, Equations (2), (4) and (6) are used to calculate the verification statistic, and the combined index is adopted therein.

The control limits can be worked out from the historical operation data and Equation (7a) to determine whether the verification statistic is lower than the control limits. If the verification statistic is lower than the control limits, it means that none failure value exists in pre-verification measurements. In such a case, the virtual analysis instrument can directly predict the output values using the scaling vector x. If the verification statistic exceeds the control limits, the process proceeds to Step 3(b).

### Step 3(b):

A failure-value set (x_{f}) is established. Let the number of the failure values (n_{f}) be zero, and let the failure-value set (x_{f}) be a null set.

### Step 3(c):

One of the scaling values of measurements is input into the failure-value set (x_{f}). The eigenvector matrix and the rest of the scaling values, which are not input into the failure-value set (x_{f}), are used to calculate the verification values (x*_{nf}) corresponding to the scaling values in the failure-value set (x_{f}) by Equation (8). Then, the verification values (x*_{nf}) and the rest of the scaling values, which are not input into the failure-value set (x_{f}), are used to calculate estimated verification statistic and record the drop value between the verification statistic and the estimated verification statistic using Equation (9).

x*_{nf}=−(ξ^{T}Φξ)⁻¹ξ^{T}Φ(I−Γ)x (8)

wherein Φ≡(I−PₖPₖ^{T})/Q_{α}+PₖΛ⁻¹Pₖ^{T}/T_{α}², and ξ≡[ξ₁ ξ₂ . . . ξ_{nf}], and wherein ξᵢ is the column vector; the ith element is 1, and the rest is zero. Γ is the diagonal matrix; the elements at the position of failure values are all 1, while the residual elements are all 0. The drop value is expressed by

φ−φ*_{nf}=(x_{nf}−x*_{nf})^{T}(ξ^{T}Φξ)(x_{nf}−x*_{nf}) (9)

wherein φ*_{nf} is the estimated verification statistic worked out from the verification values (x*_{nf}).

### Step 3(d):

Step 3(c) is repeated for (N−nf) times until all scaling values are used to estimate the corresponding drop values. One of the scaling values corresponding to the maximum drop value is assigned as a failure value, and it is input into the failure-value set (x_{f}).

### Step 3(e):

If the estimated verification statistic worked out from the verification values (x*_{nf}) is higher than the control limit, it means that there are still other failure measurements among the scaling values. Thus, Step 3(c) and Step 3(d) are repeated to select a next scaling value as a new failure value, and it is input into the failure-value set (x_{f}). Step 3(c) and Step 3(d) are repeated until the estimated verification statistic is lower than the control limit. In order to avoid assigning the scaling value as a failure value while the estimated verification statistic has been lower than the control limit, Equation (9) is rearranged into

$$ϕ - {ϕ}_{nf}^{*} = {\sum }_{i = 1}^{nf} {c}_{i} \qquad ( 10 )$$

wherein cᵢ=[(x_{nf}−x*_{nf})^{T}(ξ^{T}Φξ)^{0.5}ξᵢ]², and cᵢ is the drop value of the verification statistic contributed by the ith failure value. The greater the drop value, the higher the probability that the scaling value is a failure value. Thus, the drop values are arranged in sequence from large to small in order to further screen the failure measurements. The drop values are selected in sequence and summed up to form a drop contribution value until the estimated verification statistic subtracting the drop contribution value is lower than the control limit. The number of the preserved failure measurements can be decreased as much as possible until the estimated verification statistic approaches the control limit.

The failure values corresponding to the selected drop values have a minimum verification amount in the failure-value set (x_{f}). Then, the failure values selected from the pre-verification measurements (x) are replaced with the corresponding verification values (x*_{nf}), and then to form the input measurements for the virtual analysis instrument.

### Step 4:

The validated measurements are input into the virtual analysis instrument for predicting the outputs.

### Step 5:

The present invention is used for determining that the manufacturing measurements are valid, and the production equipment also is used for undertaking production according to the predictions of the virtual analysis instrument using the manufacturing measurements.

In conclusion, the present invention builds the verification model, uses the PCA method to verify the pre-verification measurements, and excludes failure values from the pre-verification measurements to form post-verification manufacturing measurements, whereby to prevent false pre-verification measurements from directly inputting into the virtual analysis instrument lest the virtual analysis instrument output erroneous predictions. Thereby, the present invention enables factories to achieve higher yield and higher efficiency.

What is claimed is:

1. A method for verifying manufacturing measurements used for predicting outputs by a virtual analysis instrument in a factory, the factory comprising production equipment and the virtual analysis instrument where the manufacturing measurements are input, the method comprising the steps of:
Step 1: using model-building data of the virtual analysis instrument to build a verification model via a Principal Component Analysis (PCA) method;
Step 2: using the PCA method to obtain verification-model measurements of the verification model, wherein the verification-model measurements include control limits;
Step 3: inputting a plurality of pre-verification measurements into the verification model to calculate verification statistic, and using the verification statistic and the control limits to exclude at least one failure value from the pre-verification measurements to generate validated measurements for the virtual analysis instrument;
Step 4: inputting the validated measurements into the virtual analysis instrument for predicting the outputs; and
Step 5: using the production equipment to undertake production according to predictions of the virtual analysis instrument.

2. The method according to claim 1, wherein in Step 1, the model-building data include historical operation data of the virtual analysis instrument, and the historical operation data further include at least one piece of input data and at least one piece of output data corresponding to the input data.

3. The method according to claim 1, wherein in Step 2, the verification-model measurements include a vector of an input average value, a diagonal matrix of standard deviations, a number of principal components, a diagonal matrix of corresponding eigenvalues, and an eigenvector matrix.

4. The method according to claim 3, wherein Step 3 further comprises the step of:
Step 3(a): using the vector of the input average value and the diagonal matrix of the standard deviations to transform the pre-verification measurements into a scaling vector which consists of a plurality of scaling values, and using the eigenvector matrix to project the scaling vector to a principal component subspace to calculate the verification statistic.

5. The method according to claim 4, wherein Step 3 further comprises the steps of:
Step 3(b): establishing a failure-value set;
Step 3(c): inputting one of the scaling values into the failure-value set, using the rest of the scaling values that is not input into the failure-value set and the eigenvector matrix to estimate verification values in the failure-value set, and using the verification values and the rest of the scaling values that is not input into the failure-value set to calculate estimated verification statistic and record a drop value between the estimated verification statistic and the verification statistic; and
Step 3(d): repeating Step 3(c) until corresponding drop values of all scaling values are calculated, and assigning one of the scaling values corresponding to a maximum drop value as the failure value and inputting the failure value into the failure-value set.

6. The method according to claim 5, wherein Step 3 further comprises the step of:
Step 3(e): repeating Step 3(c) to Step 3(d) to select a next scaling value as a new failure value and input the new failure value into the failure-value set until the estimated verification statistic is lower than the control limit.

7. The method according to claim 6, wherein in Step 3(e), the drop values corresponding to the failure values in the failure-value set are arranged in sequence from large to small, and sequentially selecting the drop values and summing them to generate a drop contribution value until the verification statistic subtracting the drop contribution value is lower than the control limit, and wherein the failure values corresponding to the selected drop values have a minimum verification amount in the failure-value set.

8. The method according to claim 6, wherein in Step 3, the failure values selected from the pre-verification measurements are replaced with the corresponding verification values to form the manufacturing measurements for the virtual analysis instrument.
